(19) United States
(12) Patent Application Publication
(10) Pub. No.: US 2025/0376967 A1
(43) Pub. Date: Dec. 11, 2025

(54) METHOD FOR OPERATING A DEVICE, COMPUTER PROGRAM, AND CONTROL DEVICE

(71) Applicant: Robert Bosch GmbH, Stuttgart (DE)

(72) Inventor: Alexander Wiens, Renningen (DE)

(21) Appl. No.: 19/218,805

(22) Filed: May 27, 2025

(30) Foreign Application Priority Data
May 29, 2024 (DE) 10 2024 205 018.0

(51) Int. Cl. F02M 69/00

(52) U.S. Cl. CPC F02M 69/00

(57) ABSTRACT

A method for operating a device, with one operating phase and with another operating phase, wherein during the other operating phase of the device it is provided to allocate a function for an execution. An allocation of at least three different functions is carried out according to an allocation plan.

### BACKGROUND INFORMATION

German Patent Application No. DE 10 2013 225 152 A1 describes a method for calibrating an injection insert with a high-pressure accumulator of an internal combustion engine. It is provided to calibrate a so-called pre-injection quantity regularly, since this pre-injection quantity changes over the course of the service life of the components due to drift effects. The pre-injection is usually, inter alia, calibrated under so-called overrun boundary conditions. The motor vehicle is in so-called overrun operation, which is also occasionally referred to as coasting operation. In a motorized motor vehicle, this refers to the driving state in which the internal combustion engine is in this case hauled by the motor vehicle. In this case, there is a non-disconnected frictional connection between the internal combustion engine and the rotationally moving wheels of the motor vehicle, i.e., a normal driving clutch between the internal combustion engine and the transmission is not disconnected, i.e., it is closed. The overrun or coasting operation also occurs in motor vehicles with an automatic transmission and a hydrodynamic converter.

### SUMMARY

According to a first aspect of the present invention, a method is provided for operating a device, in the operation of which one type of operating phase and a further, different type of operating phase are provided, which differs from the other operating phase in the technical execution. According to an example embodiment of the present invention, during the other operating phase of the device, it is provided that in general at least one function is allocated for an execution. Quite particularly, it is provided that an allocation of at least three different functions is carried out according to an allocation plan. These at least three different functions are allocated one after the other in an order that is to be defined (and is then defined) and, in the best case, each are executed completely, i.e., fulfill their particular technical purpose.

Depending on the length of the other type of operating phase, it can be provided that an allocation plan is fully processed during an operating phase. This applies to long operating phases, e.g., long downhill trips, in which the device (motor vehicle, internal combustion engine) is in an overrun phase, i.e., for example, in a state without power output or in a state of power consumption. In medium-length operating phases, on the other hand, it can happen that only part of an allocation plan is processed. This means that out of a certain number of allocations, which in a certain order of allocations describe the allocation plan, only a portion of these allocations will be allocated. In short operating phases, however, it may happen that only one allocation of the allocation plan is processed or even terminated prematurely, i.e., aborted, without being fully processed. A long operating phase is longer than a medium-length operating phase, which is longer than a short operating phase. Such an allocation plan has the advantage that it is clear from the outset which function is to be allocated or will be allocated for the next different operating phase. It is important, for example, that legislation could prescribe that different functions are used or are to be used when operating a device, such as, e.g., testing individual components of the device for functionality or precision of a function by using test or inspection functions. If an allocation of different functions and, more particularly, an execution of different functions in a particular ratio of the allocations is required, the required ratio can be determined or determinable from the outset by an allocation plan for the different functions in order to thereby satisfy legal requirements. Such an allocation plan can document from the beginning that the device will be checked in accordance with this allocation plan for function or proper function. As a starting point, for example, there could be an official type approval procedure for a device in general or a vehicle with an internal combustion engine in particular, where compliance with legal requirements is checked by a manufacturer or dealer before it is placed on the market (sale, use, use in road traffic). Such an allocation plan has the advantage that it makes a predictable distribution of functions possible during the operation of the device. A device in which this method is used can, for example—as in the earlier application—be a motor vehicle with an internal combustion engine and thus, for example, also part of the fuel supply. The device can, for example, also be just an internal combustion engine, the equipment of which, and thus parts of the fuel supply, is tested for functionality or precision—i.e., for example, accuracy of the metering of individual fuel quantities in order to comply with consumption quantities or exhaust gas composition. However, the range of applications is not limited to devices that are exclusively related to internal combustion engines. For example, it may also be possible for the device on which the functions are executed to be a device with an electrical or electronic unit, such as a motor vehicle with an electric motor or, more generally, an electrical machine that is controlled by an inverter, for example, for motor operation or generator operation. For example, the allocated functions could test the functionality of individual components of the electrical or electronic unit.

According to an example embodiment of the present invention, in the case of the device designed as an internal combustion engine or motor vehicle with an internal combustion engine, the one operating phase can be, for example, a state of power output or drive phase. In the case where the device is an electrical machine, the switched-on state here as well means a state of power output, i.e., a drive phase, i.e., operation as an electric motor. In the case where the device is an internal combustion engine or motor vehicle with an internal combustion engine, the other operating phase would be, for example, a switched-off state, a state without power output or a state of power consumption of the device designed as an internal combustion engine or motor vehicle with an internal combustion engine, wherein the state of power consumption is, for example, a so-called overrun phase. The other operating phase for an electrical machine would be a state of power consumption in which, for example, mechanical energy is converted into electrical energy (generator operation) or, alternatively, idling operation in which neither electrical energy is converted into mechanical energy nor mechanical energy is converted into electrical energy.

According to a further aspect of the present invention, it is provided that the allocation plan is formed from a plurality of sub-plans. For example, it can be provided that two sub-plans are created if a total of three different functions are to be allocated within the allocation plan. Alternatively, or if necessary, an allocation plan for allocating three different functions may be formed from three sub-plans. If, for example, four different functions or types of functions are to be allocated—for example, with different allocation numbers—the allocation plan can be formed from four different sub-plans or, in a simplified form, from three sub-plans. Or to put it another way: if the number of different functions or function types is nF, then it is provided that a number of a plurality of sub-plans corresponds to nTP=nF−1. If, for example, nF=3, the allocation plan can be formed from two sub-plans. If, for example, nF=4, the allocation plan can be formed from three sub-plans. If, for example, nF=5, the allocation plan can be formed from four sub-plans. Such an approach or procedure, according to which the allocation plan is formed from a plurality of sub-plans, makes it structurally and systematically possible to determine the most uniform distribution possible of the individual functions in the allocation plan in accordance with the provided shares of allocations and their uniform distribution. An allocation plan can comprise a plurality of basic patterns—for example, two identical basic patterns.

Furthermore, according to an example embodiment of the present invention, it is provided to ascertain a second sub-plan based on the types and all allocations of functions that occupy the positions for placeholder functions in the first sub-plan, wherein in this second sub-plan positions for the allocations of a function are determined, in particular for the function that comprises the most allocations in the second sub-plan, and positions for placeholder functions are determined.

For example, according to an example embodiment of the present invention, it is provided that a function is only allocated within the framework of a basic pattern. This can have the advantage that legal requirements can be met. This is true in particular if the basic pattern comprises a specifiable ratio of allocations of the different functions.

According to an example embodiment of the present invention, if a function of the basic pattern is terminated after incomplete processing, this can have the advantage that driving the vehicle or using the device is more comfortable than if it were first necessary to wait for complete processing of the basic pattern.

According to an example embodiment of the present invention, if the function that is terminated after incomplete processing is followed by at least one further function in the basic pattern, the next function to be allocated in the basic pattern is allocated according to the basic pattern. This can also have the advantage that legal requirements can be met.

It has turned out that the determination of a sub-plan can be reliably determined by the following steps: according to a further aspect of the present invention, it is provided that a sub-plan is determined by the following steps: a dividend and a divisor are determined, and a step is performed which is at least equivalent to an integer division with the dividend and the divisor. The dividend corresponds to a sum of the numbers of the multiple types of functions and a sum of their specified numbers of allocations of a multiple of a basic pattern. To determine the divisor, a plurality of types of functions and a sum of their given numbers of allocations of the multiple of a basic pattern are used, thus forming a set. There are more types of functions of the dividend than there are types of functions of the divisor. An integer quotient of integer division is done in one step, a remainder of integer division is performed in another step.

In this case, it can be advantageously provided that, before performing the step that is equivalent to the division, either the dividend and the divisor are fully reduced or it is determined that the dividend and the divisor are fully reduced.

In connection with allocating functions, it is provided to store a feature which makes it possible to determine the next function of the basic pattern to be allocated. In particular, it is provided that in connection with allocating functions, a current position in the allocation plan, in particular the last allocated position or the next position to be allocated, is stored.

According to a further example embodiment of the present invention, it is provided that an allocation plan is generated in a control device in the motor vehicle. With such a procedure, individual features of the motor vehicle can be included. Alternatively, an allocation plan can be generated outside the control unit and then stored, in particular unchangeably, in a memory of the motor vehicle. In the procedure mentioned last, it is possible for corresponding devices in the motor vehicle not to have to be equipped with corresponding software and computer capacity for generating the allocation plan. The allocation plan is read from the memory, for example to use it or to check its correctness.

The mentioned different functions, which are allocated for use in connection with the allocation plan, comprise, for example, a function for monitoring a quantity of injected fuel and a function for adapting a small quantity of injected fuel or fuel to be injected.

Furthermore, a computer program is provided and designed to perform all steps of one of the methods of the present invention or is programmed in such a way that a method according to the present invention is performed when the computer program is executed on a computer.

The present invention is explained in more detail using the figures, listed below, and a table.

### BRIEF DESCRIPTION OF THE DRAWINGS

FIG. 1 shows a motor vehicle with an internal combustion engine, part of its fuel supply system, a control device, and its drive train, according to an example embodiment of the present invention.

FIG. 2 shows a schematic execution of the method, according to an example embodiment of the present invention.

FIG. 3 shows, for a first example of three different functions F1, F2, F3 to be allocated, the number of allocations that are to be distributed over a basic pattern, according to an example embodiment of the present invention.

FIG. 4 shows a first sub-plan, which precedes the formation of the basic pattern, according to an example embodiment of the present invention.

FIG. 5 shows a second sub-plan according to an example embodiment of the present invention. The concatenated allocations are distributed accordingly to the first sub-plan.

FIG. 6 shows an exemplary basic pattern, which can be formed, by way of example, according to the first example of a relationship of allocations of the functions F1, F2, F3.

FIG. 7 to FIG. 11 show a second exemplary embodiment of the present invention.

FIG. 12 to FIG. 15 show a third exemplary embodiment of the present invention.

FIG. 16 to FIG. 20 show a fourth exemplary embodiment of the present invention.

FIG. 21 shows a temporal sequence of a trip of a motor vehicle after it has been started at time t=0 using the first exemplary embodiment of a sequence of allocations, according to the present invention.

FIG. 22 shows a second temporal sequence of a trip of a motor vehicle after it was started at time t=0 using the first exemplary embodiment of a sequence of allocations, according to the present invention.

### DETAILED DESCRIPTION OF EXAMPLE EMBODIMENTS

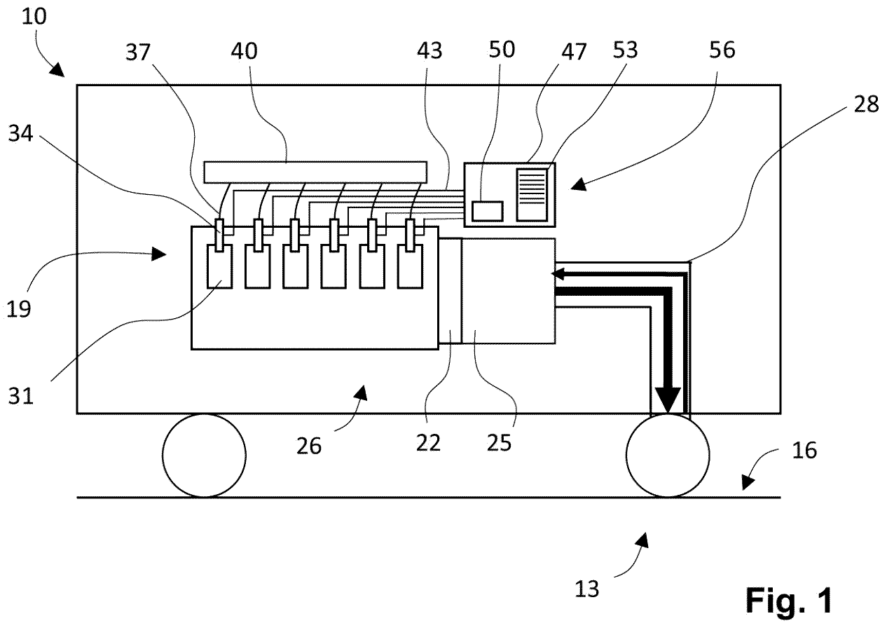

FIG. 1 shows a motor vehicle 10 which has at least one drive means 13, preferably in the form of an at least one wheel. The motor vehicle 10 with the drive means 13 stands on a ground 16 and typically moves on this ground 16. The motor vehicle 10 also has an internal combustion engine 19, which is connected to a transmission 25 by means of a clutch 22. The internal combustion engine 19, the clutch 22 and the transmission 25 are part of a drive train 26. The transmission 25 supplies a further part of the drive train 26, the drive train part 28, with mechanical energy (torque, rotational speed) and thus drives the drive means 13. If the internal combustion engine 19 drives the motor vehicle 10, the internal combustion engine 19 drives (rotational speed, torque) a drive shaft (not shown here), which drives a clutch input part of the clutch 22. If the clutch 22 is switched to transmit torque, a clutch output part transmits mechanical energy to an input shaft of the transmission 25. Depending on the selected gear stage in the transmission 25, the mechanical energy is passed, with an output speed dependent thereon and an output torque dependent thereon, to the drive train part 28 and is transmitted to the drive means 13. This describes the drive state of the motor vehicle 10. So that the internal combustion engine 19 can transmit a torque, fuel is introduced into the individual cylinders 31 in a conventional manner, is ignited, and the torque on a crankshaft as a drive shaft is generated by the intended combustion in the cylinders 31. Fuel is fed to the injectors 34 via individual fuel supply lines 37, coming from a high-pressure accumulator 40 for fuel (for example, a common rail). For this purpose, the individual injectors 34 are controlled by a control unit 47. For this purpose, energy is supplied to drive elements (not shown here) of the injectors 34 via electrical connections 43 at the correct times so that valves of the injectors 34 can open. A processor 50 in which the provided commands are processed is located in the control unit 47. In addition, a memory 53 for data, in particular digital data, is preferably located in this control unit 47. These data in this memory 53 can, for example, comprise a computer program 56 which is designed to perform all steps of one of the methods or which is programmed in such a way that it performs a method when it is executed on a computer (processor 50, control unit 47).

During operation of the internal combustion engine 19, it is provided that various functions are executed on the internal combustion engine 19. These functions include, for example, the function F1, the function F2 and the function F3, which differ from each other (F1 not equal to F2, F2 not equal to F3, F3 not equal to F1). The function F1 can be, for example, a so-called quantity monitoring function and the function F2 can be a so-called small quantity adaptation function; the function F3 is a function that has a different task than the functions F1, F2. This function F3 can, for example, be a function F3 whose allocation requires that the injectors 34 do not introduce any fuel into a cylinder 31 (overrun operation/overrun phase of the motor vehicle 10) indirectly (intake manifold injection) or directly (direct injection) for at least part of the temporal sequence of the function F3. For example, at least one sensor can be calibrated in an exhaust tract of the motor vehicle 10. The execution of these functions F1, F2, F3 in principle takes place as intended during an overrun phase of the internal combustion engine 19. For other devices that are not internal combustion engines, this can be carried out in other phases, as described above.

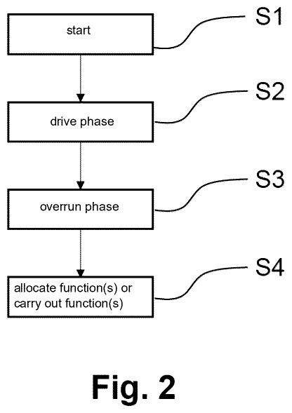

When a motor vehicle 10 is started, FIG. 2, (start S1), a drive phase S2 is typically initiated first thereafter and performed. During such a drive phase S2, mechanical energy is transmitted via the drive train 26 onto or to the drive means 13, so that the motor vehicle 10 can move on the ground 16 in the driven state. If such a motor vehicle 10 is moved for example in the inner city and if, for example, this motor vehicle 10 approaches a traffic light signaling “stop,” an operating mode of the motor vehicle 10 is typically changed from a drive phase S2 to an overrun phase S3. In this overrun phase S3, the internal combustion engine 19 does not provide any mechanical energy; rather, this internal combustion engine 19 receives energy in the overrun phase S3, which is symbolically depicted by the narrower arrow between the drive means 16 and the transmission 25. The wide arrow symbolizes the case of transmitting drive energy from the internal combustion engine 19 to the drive means 13. The allocation of a function F1, F2, F3, or function F1, F2, . . . , Fi, in a step S4 is carried out according to an allocation plan P. In principle, here a method for operating a motor vehicle 10, which has a drive train 26 with an internal combustion engine 19, is provided. During a trip, the motor vehicle 10 is operated at least once in an overrun phase S3. In this case, it is provided that, during the overrun phase S3, at least one function F1, F2, F3 or function F1, F2, . . . , Fi is to be allocated for an execution on the internal combustion engine 19. An allocation S4 of different functions F1, F2, F3 or function F1, F2, . . . , Fi is carried out according to an allocation plan P.

A method is thus provided for operating a device, such as a motor vehicle 10 or an internal combustion engine 19 or an electric motor, wherein during operation an operating phase, for example a drive phase S2, and another operating phase, for example an overrun phase S3, is executed or are used. During the other operating phase of the device, it is provided to allocate a function F1, F2, F3 or function F1, F2, . . . , Fi for an execution. It is typically provided that an allocation of at least three different functions F1, F2, F3 or function F1, F2, . . . , Fi is carried out according to an allocation plan P. An allocation of at least three different functions F1, F2, F3 or function F1, F2, . . . , Fi according to the allocation plan P can be carried out over a plurality of other operating phases, e.g. a plurality of overrun phases.

In principle, this allocation plan P has a basic pattern 100, which is repeated during the method. Such a basic pattern 100 has a sequence of allocations S4 of one function F1, of allocations S4 of the function F2, of allocations S4 of the other function F3, up to allocations S4 of the last function Fi.

A first exemplary embodiment for creating a basic pattern for three functions F1, F2 and F3 is described below.

First, a first sub-plan TP1 is described, from which a partial basic pattern TGM1 results.

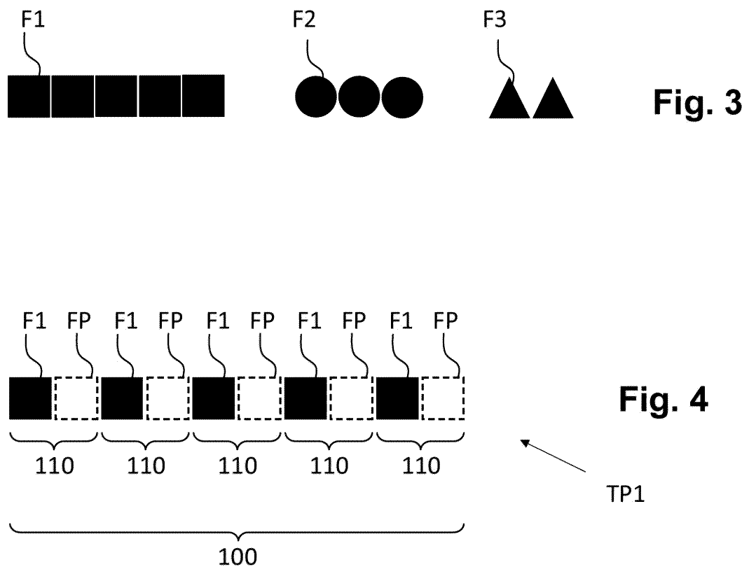

The representations in FIGS. 3 and 4 schematically show the composition of an exemplary basic pattern 100. FIG. 3 shows that this exemplary basic pattern 100 has and is intended to have a specifiable, and here specified, ratio of allocations S4 of the one function F1, of allocations S4 of the function F2 and of the other function F3. For example, it is provided that the basic pattern 100 provided here has or is intended to have a specifiable ratio of allocations of the one function F1, the allocations of the function F2 and the allocations S4 of the other function F3 in the ratio of n1/n2/n3=5:3:2.

Accordingly, FIG. 3 symbolically shows five functions F1, three functions F2 and two functions F3. Alternatively or synonymously, it can also be formulated that a basic pattern 100 has a specified number n1 of allocations S4 of the one function F1 and a specified number n2 of allocations S4 of the function F2 and a specified number of allocations S4 of the other function F3.

As shown, the allocation plan P has at least one basic pattern 100, which is formed from a plurality of sub-plans TP1, TP2, . . . , TPn. For this first example, two sub-plans TP1, TP2 are created and used.

The determination of the first sub-plan TP1 in the sense of a partial basic pattern TGM1 of a basic pattern 100 takes place as follows:

FIG. 4 shows that, in the given ratio of allocations S4 of the one function F1 and of a sum of allocations S4 of the other functions F2, F3 in the ratio of (n1+n2+n3)/(n1)=10:5=2, five subgroups 110 result, each having one function F1 and one placeholder function FP (two functions per subgroup 110). In this case, the basic pattern 100 results from the sequence of the five subgroups 110, each consisting of a function F1 and a placeholder function FP. The mentioned ratio of (n1+n2+n3)/(n1) is formed as the quotient of the sum of all functions F1, F2, F3 to be allocated of a basic pattern 100 and the largest number of allocations of a function, here F1. Here as well, a number of allocations S4 of a subpattern 110 is determined, wherein the number of allocations S4 corresponds to the magnitude of the integer quotient QD. When determining the remainder, it is determined that the set of the remainder is an empty set. If the set were not empty, the element or elements of the set of the remainder would represent a set of allocations S4 of the function F1, i.e. the size of the remainder would represent a number n4 of the functions F1. The description given above for creating the first sub-plan TP1 corresponds in principle to the procedure for creating a basic pattern 100 for two functions F1, F2, which is applied here to a function F1 and a placeholder function FP (which in principle represents a function F2).

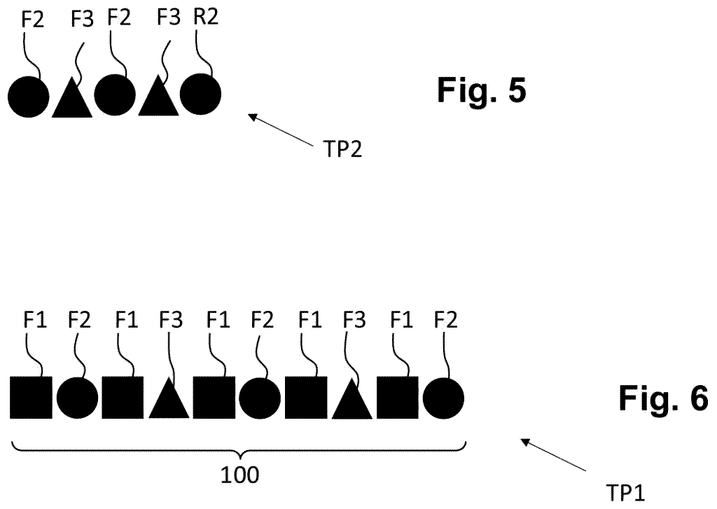

FIG. 5 shows how the second sub-plan TP2 (sub-basic pattern TGM2) is composed of the allocations S4 of the other functions F2, F3. The creation of the second sub-plan TP2 is explained as follows. The creation of the second sub-plan TP2 corresponds in principle to the procedure for creating a basic pattern 100 for two functions F1, F2, which is applied here to a function F2 and a function F3 (which thus in principle represent the functions F1, F2).

A basic pattern 100 can in this case be determined according to the method described below. As already mentioned, a specified number n1 of allocations S4 of the one function F1, a specified number n2 of allocations S4 of the one function F2 and a specified number n3 of allocations S4 of the other function F3 are to be performed per basic pattern. The presented method is intended to ensure that these allocations are distributed as uniformly y as possible within the basic pattern. In the example according to FIGS. 3 and 4, this means that n1=5, n2=3 and n3=2.

Since more than two types of functions, here three types, are to be allocated, two sub-plans TP1, TP2 must be determined. In order to determine the basic pattern 110, an integer division is performed in a step P1. The dividend Dd1 is ascertained as the sum of the specified number of allocations to different functions per basic pattern. Here, the sum of the specified number n1 of allocations S4 of the one function F1 per basic pattern 100 and the specified number n2 of allocations S4 of the function F2 and the specified number n3 of allocations S4 of the function F3 per basic pattern 100 is ascertained (Dd1=n1+n2+n3=10). For example, the divisor Dr1 corresponds to the sum of the number n2 of allocations S4 of the function F2 and the number n3 of allocations S4 of the function F3 per basic pattern 100, Dr1=n5. Before performing step P1, which is at least equivalent to the integer division, either the dividend Dd1 and the divisor Dr1 are fully reduced or it is determined that the dividend Dd1 and the divisor Dr1 are fully reduced. In the division to be performed here, it is determined that the dividend Dd1 and the divisor Dr1 are not fully reduced (Dd1/Dr1=10/5). In the specific case according to the exemplary embodiment according to FIGS. 3 to 5, this means that after the complete reduction an integer division 2:1 is performed. From this division, the so-called integer quotient QD1 of the integer division (step P1) is determined in step P2. From this integer division, the number 2 results as the integer quotient QD1. The number QD corresponds to a length of a subpattern 110, which thus comprises two allocations S4 from the set of functions F1, F2, F3 to be allocated. According to this integer division, there is no remainder R1 in step P3.

Subsequently, a number n3 of subpatterns 110 is determined by setting this number equal to the divisor. This means that the number of subpatterns 110 in this case Dr1=5. Since there is no remainder R1, no step P4 is performed in this case and thus no allocation S4 of a function F1 is added to any subpattern 110. However, such a case will be described later in this description. The first sub-plan TP1 is formed from a sequence of a number Dr1 of subpatterns 110, FIG. 4. Each subpattern 110 has an allocation of a function F1 and an allocation of a placeholder function FP. A placeholder function FP initially stands for an indeterminate function, which in this example can be a function F2 or a function F3. The second sub-plan TP2 determines the order in which the allocations S4 of the functions F2, F3 are distributed among the concatenated subpatterns. Accordingly, it is determined which placeholder function FP is replaced by which function F2, F3.

The second sub-plan TP2 is determined as follows: in this case as well, subgroups 110 are determined, which are designated the same here, even if they are composed differently. In addition, the determination of the second sub-plan TP2 results in a remainder R2, as will be seen below. In order to determine the size or length of a subgroup 110 of the second sub-plan TP2 (which structurally corresponds to a basic pattern 100), an integer division is again performed in a step P1. The dividend Dd2 is ascertained as the sum of the specified numbers of allocations to different functions F2, F3 of the second sub-plan TP2. Here, the sum of the specified number n2 of allocations S4 of the one function F2 of the second sub-plan TP2 and the specified number n3 of allocations S4 of the function F3 of the second sub-plan TP2 is ascertained (Dd2=n2+n3=5). For example, the divisor Dr2 corresponds to the sum of the number n3 of allocations S4 of the function F3 of the second sub-plan TP2, Dr2=2. Before performing step P1, which is at least equivalent to the integer division, either the dividend Dd2 and the divisor Dr2 are fully reduced or it is determined that the dividend Dd2 and the divisor Dr2 are fully reduced. In the division to be performed here, it is determined that the dividend Dd2 and the divisor Dr2 are fully reduced (Dd2/Dr2=5/2). In the specific case according to the exemplary embodiment according to FIGS. 3 to 5, this means that an integer division 5:2 is performed. From this division, the so-called integer quotient QD2 of the integer division (step P1) is determined in step P2. From this integer division, the number 2 results as the integer quotient QD2. The number QD2 corresponds to a length of a subpattern 110 of the second sub-plan TP2, which thus comprises two allocations S4 from the set of functions F2, F3 to be allocated. Corresponding to this integer division, a remainder R2=1 results in step P3.

Subsequently, a number n3 of subpatterns 110 is determined by setting this number equal to the divisor. This means that the number n3 of subpatterns 110 in this case is Dr2=2. Since there is a remainder R2, in this case a step P4 is performed and thus an allocation S4 of a function F2 is added to a subpattern 110, FIG. 5. The second sub-plan TP2 is formed from a concatenation of a number Dr2=2 of subpatterns 110, FIG. 5. Each subpattern 110 has an allocation of a function F2 and an allocation of a placeholder function TP, which are easily replaced with the allocations of the function F3. This can be carried out, for example, in the order F2-F3 or in the order F3-F2. However, the selected order must be adhered to for an example in order to achieve as accurate a distribution as possible in accordance with the specified ratio, in this case n1/n2/n3=5:3:2. As mentioned, an allocation S4 of the function F2 is added to one of the subpatterns 110 according to the size of the remainder R2. The pattern of an order of allocations S4 of the individual functions F2, F3 of the second sub-plan TP2 can, for example, look as shown in FIG. 5: (from left to right) F2-F3-F2-F3-F2 or (from right to left) F2-F3-F2-F3-F2. Since an allocation S4 of the function F2 is added according to the size of the remainder R2 and this does not necessarily have to be appended to the last function of the second subgroup 110 (FIG. 5), but can also be added to the first subgroup 110, the second sub-plan TP2 can also be determined as follows: (from left to right) F2-F3-F2-F2-F3 or (from right to left) F3-F2-F2-F3-F2. In general, with respect to the individual functions that are generally part of the remainder R, here in the example of the remainder R2, and that are to be assigned to the totality of the subpatterns 110 of a plan in general, here in particular of a, or the, sub-plan TP2, the procedure can be such that a function of the remainder R (R2) is placed in front of a first subpattern 110. In the case where there is a second function of the remainder R (R2), this is to be placed in front of the next (second) subpattern 110. In the case where there is a third function of the remainder R (R2), this is to be placed in front of the next (third) subpattern 110. And so on and so forth. Or, to put it more generally: if the remainder R (R2) has a set with nR functions, then a function of the remainder R (R2) can be assigned to the first nR subpatterns 110, in particular can be placed before or after them.

The order of allocations S4 of the functions F2, F3 according to the second sub-plan TP2 are correspondingly distributed or assigned to the basic pattern 100 according to the sub-plan TP1 (compare with FIG. 4) after determining their order in the sub-plan TP2; compare with FIG. 6. Thus, according to the basic representation in FIG. 4 a basic pattern 100 results for example as follows:
F1-F2-F1-F3-F1-F2-F1-F3-F1-F2 (as shown in FIG. 6 from left to right), or
F1-F2-F1-F3-F1-F2-F1-F2-F1-F3, or
F1-F3-F1-F2-F1-F2-F1-F3-F1-F2, or
basic patterns 100 whose allocations S4 are arranged in the reverse direction:
F2-F1-F3-F1-F2-F1-F3-F1-F2-F1 (corresponds to the reverse of the example of a basic pattern 100 according to FIG. 6), or
F3-F1-F2-F1-F2-F1-F3-F1-F2-F1, or to
F2-F1-F3-F1-F2-F1-F2-F1-F3-F1.

From the description of the above exemplary embodiment, a method is thus provided according to which a number nF of different functions F1, F2, F3, . . . Fi is allocated, wherein a number nTP of sub-plans TP1, TP2, . . . , TPn from which the allocation plan P is formed is at least the number nF of different functions F1, F2, F3, . . . , Fi reduced by 1 (nF−1).

As can be seen from the description of the first exemplary embodiment, a first sub-plan TP1 is ascertained on the basis of all functions F1, F2, F3, . . . Fi to be allocated. This first sub-plan TP1 has positions for placeholder functions TP. The first sub-plan TP1 comprises allocation positions for all types of functions F1, F2, F3, . . . , Fi to be allocated, wherein initially only the positions of the function F1 are determined.

The function F1 is preferably the function F1 with the most allocations S4 in the basic pattern 100.

The second sub-plan TP2 comprises allocation positions for the functions F2, F3, . . . , Fi to be allocated, which were not specifically determined in the first sub-plan TP1, i.e. for the positions in the first sub-plan TP1 which are designated there with the placeholder TP. The procedure for determining the second sub-plan TP2 is the same as for the first sub-plan TP1. As can be seen from the description of the first exemplary embodiment, a second sub-plan TP2 is ascertained on the basis of all functions F2, F3, . . . Fi to be allocated, which are not yet specifically determined in the first sub-plan TP1. This second sub-plan TP2 has placeholders TP. The second sub-plan TP2 comprises allocation positions for all functions F2, F3, . . . , Fi to be allocated, wherein initially only the positions of function F2 are determined. The function F2 is preferably the function F2 with the most allocations S4 of the functions F2, F3, . . . , Fi to be allocated according to the second sub-plan TP2. The second exemplary embodiment and the manner in which the corresponding basic pattern is to be formed in principle corresponds to the method for the first exemplary embodiment.

In this second exemplary embodiment, 43 allocations of the function F1, 40 allocations S4 of the function F2 and 17 allocations S4 of the function F3 are to be performed. A basic pattern 100 is to be formed as shown in FIG. 4. The assembly of the basic pattern 100 is to be performed using a first sub-plan TP1 and a second sub-plan TP2. For example, it is provided that the basic pattern 100 provided here has or is intended to have a specifiable ratio of allocations of the one function F1, the allocations of the function F2 and the allocations S4 of the other function F3 in the ratio of n1/n2/n3=43:40:17. Alternatively or synonymously, it can also be formulated that a basic pattern 100 has a specified number n1 of allocations S4 of the one function F1 and a specified number n2 of allocations S4 of the function F2 and a specified number of allocations S4 of the other function F3.

The determination of the first sub-plan TP1 in the sense of a partial basic pattern TGM1 of a basic pattern 100 takes place as follows:

In order to determine the basic pattern 100, an integer division is performed in a step P1. The dividend Dd is ascertained as the sum of the specified number n1 of allocations S4 of the one function F1 per basic pattern 100 and the specified number n2 of allocations S4 of the other function F2 per basic pattern 100 and the specified number n3 of allocations S4 of the other function F3 per basic pattern 100 (Dd=n1+n2+n3=43+40+17=100). The divisor Dr corresponds to the number n1 of allocations S4 of the other function F1 per basic pattern 100, Dr=n1=43. Before performing step P1, which is at least equivalent to the integer division, either the dividend Dd and the divisor Dr are fully reduced or it is determined that the dividend Dd and the divisor Dr are fully reduced. In the division to be performed here, it is determined that the dividend Dd and the divisor Dr are fully reduced (Dd/Dr=100/43).

Analogous to the representation in FIG. 4, for the given ratio of allocations S4 n1/n2/n3=43:40:17, a number of subgroups 110 of the first sub-plan TP1 is ascertained as follows: a quotient is determined of the number of all allocations per basic pattern with the largest set of allocations to be performed for one of the functions:

$$( n 1 + n 2 + n 3 ) / = 100 : 43 = 2 , remainder R = 14 .$$

From this division, the so-called integer quotient QD of the integer division (step P1) is determined in step P2. From this integer division, the number 2 results as the integer quotient QD. The number QD corresponds to a length of a subpattern 110, which thus corresponds in each case to an allocation S4 of the functions F1 and a placeholder function FP, which corresponds to an allocation from the set of allocations S4 of the functions F2, F3. According to this integer division, the number R=14 results in step P3 as the remainder R of this integer division.

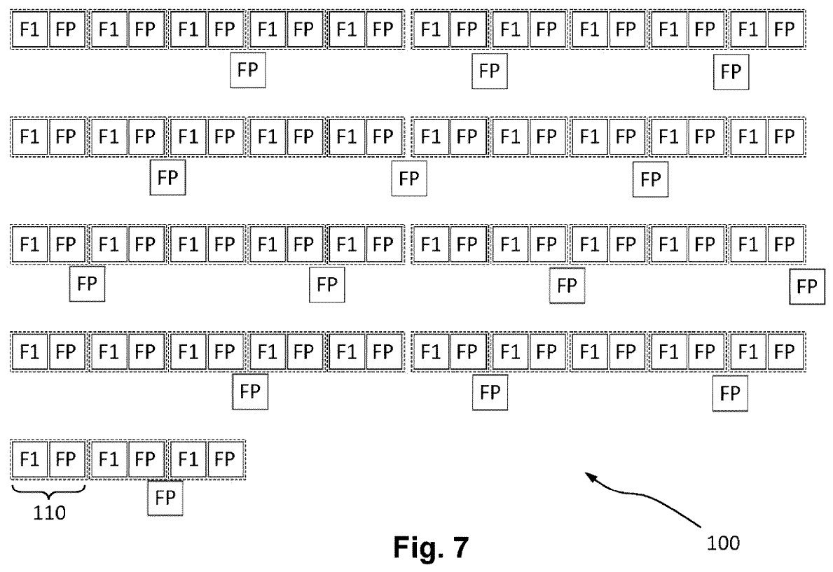

That is, n1=Dr=43 subgroups 110 are determined from one function F1 and one placeholder function FP (2 functions per subgroup 110). In addition, R=14 allocations S4 are ascertained, which are distributed among the subgroups 110. In this example, the basic pattern 100 results from the sequence of the 43 subgroups 110, each consisting of a function F1 and a placeholder function FP, and an additional 14 allocations of the remaining functions. The 14 allocations are preferably distributed uniformly or as uniformly as possible among the 43 subgroups or 86 allocations. This results in the arrangement of subgroups 110 shown in FIG. 7. At the positions indicated in FIG. 7 between two subgroups 110, a total of 14 placeholder functions FP from the remainder R=14 are to be inserted into the series or sequence of 43 subgroups 110. Dividing Dr=43 with the remainder R=14 results in the number 3 remainder R=1. This means that after every third subgroup 110, a placeholder function FP from the set of the remainder R=14 has to be positioned (FIG. 7) in order to achieve the most uniform distribution of the functions of the remainder. Given the remainder R=1, after the last position of a placeholder function FP to be inserted there is a remaining subgroup 110. In principle, such an outlined arrangement of a first sub-plan TP1 could already be accepted or implemented in a control device, which would still have to be supplemented by the arrangement according to the second sub-plan TP2. This is particularly important in view of the fact that given, for example, hundreds of thousands of functions to be allocated during a “vehicle life,” such a minimal asymmetry within TP1 is practically insignificant. This practical insignificance results from the fact that the next pattern follows, with three subgroups 110, following the same first sub-plan TP1. Accordingly, at a transition point between two immediately following allocations and two placeholder functions FP resulting from the remainder, four subgroups 110 would always be arranged at the end of a basic pattern 100 and at the beginning of a basic pattern. Thus, only in the case of a basic pattern 100 and only within a basic pattern 100 which is formed according to FIG. 7 is there an asymmetry of the beginning and end of the basic pattern 100.

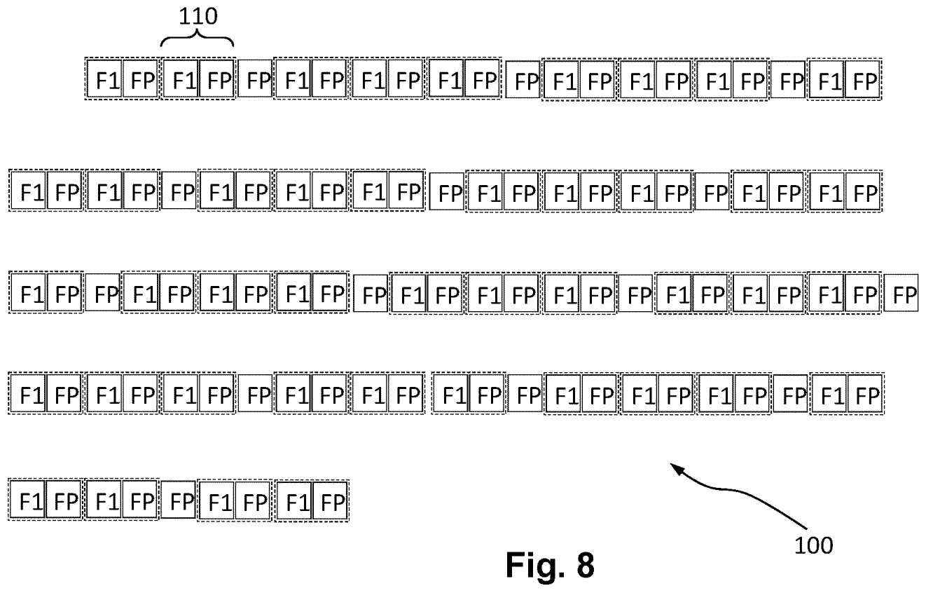

In FIG. 8, as an alternative to FIG. 7, a basic pattern 100 is shown which is symmetrical with respect to the arrangement of the placeholder functions FP from the set of the remainder R=14. The basic pattern 100 according to the first sub-plan TP1 is also to be read or allocated from top left to bottom right. As can be seen, the basic pattern begins after sub-plan 1 with two subpatterns 110 before, immediately afterwards, a placeholder function FP is allocated from the remainder. The basic pattern 100 according to the sub-plan 1 ends with two subpatterns 110 to which a placeholder function FP is immediately allocated from the remainder. In between, the distances between placeholder functions FP from the rest are uniformly spaced.

The determination of the second sub-plan TP2 in the sense of a partial basic pattern TGM2 of a basic pattern 100 takes place as follows:

In this case as well, subgroups 110 are determined, which are designated the same here, even if they are composed differently. In addition, the determination of the second sub-plan TP2 results in a remainder R2, as will be seen below. In order to determine the size or length of a subgroup 110 of the second sub-plan TP2 (which structurally corresponds to a basic pattern 100), an integer division is again performed in a step P1. The dividend Dd2 is ascertained as the sum of the specified numbers of allocations to different functions F2, F3 of the second sub-plan TP2. Here, the sum of the specified number n2 of allocations S4 of the one function F2 of the second sub-plan TP2 and the specified number n3 of allocations S4 of the function F3 of the second sub-plan TP2 is ascertained (Dd2=n2+n3=57). For example, the divisor Dr2 corresponds to the number n3 of allocations S4 of the function F3 of the second sub-plan TP2, Dr2=17, and also to the number of subgroups 110 of the second sub-plan TP2. Before performing step P1, which is at least equivalent to the integer division, either the dividend Dd2 and the divisor Dr2 are fully reduced or it is determined that the dividend Dd2 and the divisor Dr2 are fully reduced. In the division to be performed here, it is determined that the dividend Dd2 and the divisor Dr2 are fully reduced (Dd2/Dr2=57/17). In the specific case according to the exemplary embodiment, this means that an integer division 57:17 is performed. From this division, the so-called integer quotient QD2 of the integer division (step P1) is determined in step P2. From this integer division, the number 3 results as the integer quotient QD2. The number QD2 corresponds to a length of a subpattern 110 of the second sub-plan TP2, which thus comprises three allocations S4 from the set of functions F2, F3 to be allocated. Corresponding to this integer division, a remainder R2=6 results in step P3.

The mentioned ratio of (n2+n3)/(n2) is formed as the quotient of the sum of all functions F2, F3 of a basic pattern 100 of the sub-plan TP2 to be allocated for this sub-plan TP2 and the largest number of allocations of a function for this sub-plan TP2, here F2.

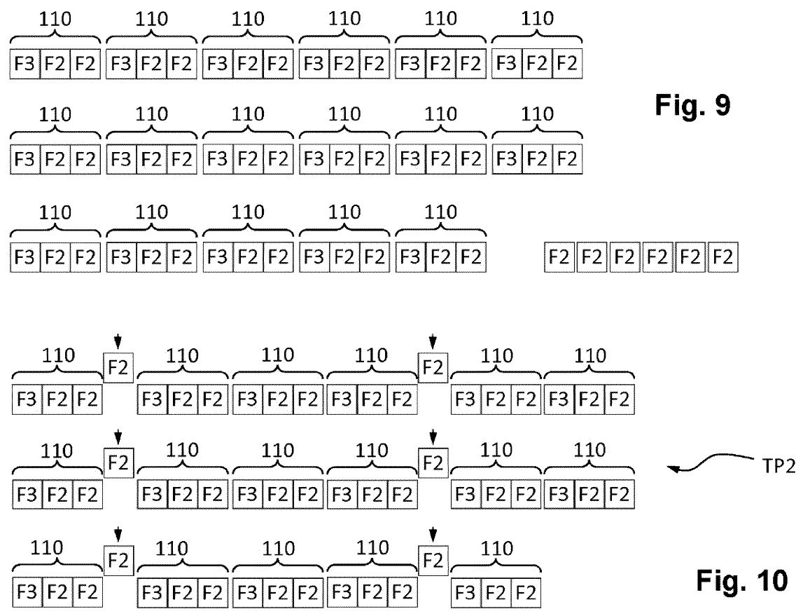

The remaining six functions F2 are not yet distributed according to FIG. 9. The creation of the second sub-plan TP2 is explained using the following FIGS. 9 and 10. FIG. 9 shows how the second sub-plan TP2 (sub-basic pattern TGM2) is in principle composed of the allocations S4 of the other functions F2, F3 (17 subgroups, 6 allocations from the remainder of six functions).

There are 17 subgroups 110, each with three allocations. Here, every first allocation of a subgroup 110 is an allocation S4 of a function F3. The remaining or subsequent allocations S4 of a subgroup 110 are carried out entirely with functions F2. In order to achieve the greatest possible symmetry within a sub-plan TP2, the six functions F2 determined by the remainder are distributed in such a way that after a first subgroup 110, a first function F2 is placed from the remainder, and then, at regular intervals after every three further subgroups 110, the following allocations of the functions F2 of the remaining five functions F2 from the remainder, FIG. 10. Alternatively, the following procedure can be used: if the remainder R (R2) has a set with nR functions, then a function of the remainder R (R2) is to be assigned to the first subpattern 110, in particular placed before or after it. Starting from this first subpattern 110, the following allocations of the functions F2 of the remaining (here five) functions F2 from the remainder are assigned to the particular subpattern 110 at the determined regular interval, here after every three further sub-groups 110, in particular are placed before or after, preferably placed before or after as in the first subpattern 110.

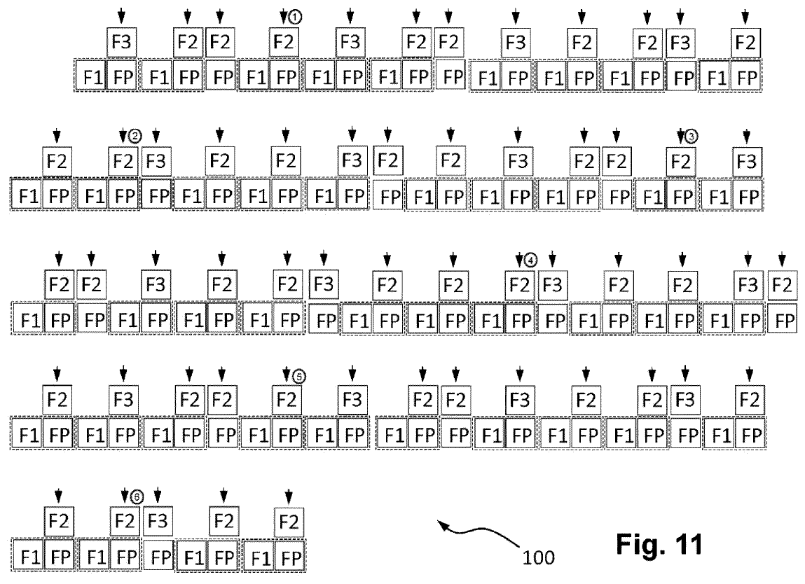

In this example, a number n4 of functions F2 is determined, wherein the number n4 corresponds to the size of the remainder R. The basic pattern (100), or a sub-plan, is formed from this number n4 of functions F2 and with the number n3 of subpatterns 110. The number n4 of functions F2 of the remainder is distributed uniformly over the number n3 of subpatterns 110. The corresponding positions are marked with circled numbers in FIG. 11.

This creates a second sub-plan TP2, which is to be incorporated into the first sub-plan TP1 with the allocations S4 of the functions F2 and F3, FIG. 11. The functions to be incorporated from the second sub-plan TP2 are positioned according to their position in the second sub-plan TP2 at the provided locations of a placeholder function FP of the first sub-plan TP1 to be replaced.

Accordingly, a sequence is formed which is a basic pattern 100. Due to the ratios of the allocations, it again does not matter whether this basic pattern is allocated in the order from left (top left) to right (bottom right) or from right (bottom right) to left (top left).

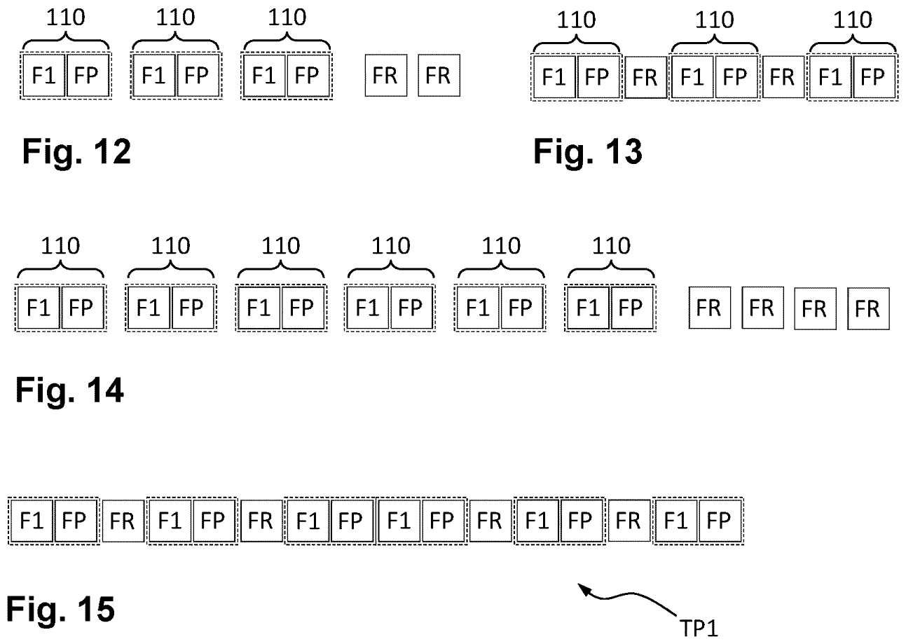

In the third exemplary embodiment according to FIGS. 12 to 20, a total of 16 allocations S4 are to be performed. A ratio of the allocations of the functions F1, F2, F3 and F4 is to be n1/n2/n3/n4=6/5/3/2.

The third exemplary embodiment and the manner in which the corresponding basic pattern is to be formed in principle corresponds to the methods for the first and second exemplary embodiments. The difference to be provided for is to provide and determine a third sub-plan TP3 in view of a fourth function F4 to be allocated.

First, a sub-plan TP1 is determined which clarifies the arrangement of the allocations S4 of the function F1 in first subgroups 110, their number and the remainder R. The known procedures result in a first dividend Dd1=16 and a first divisor Dd1=6. After recognizing that it is necessary or possible to reduce (see above), an integer quotient QD1=2 and a remainder R1=2 result in a known manner. The number of subpatterns 110 is 3, see FIG. 12. Each subpattern 110 is to begin with a function F1, followed by a placeholder function FP, to which a function F2, F3 or F4 will be allocated. The remaining functions FR are to be distributed as uniformly as possible among the subpatterns 110, FIG. 13. Given that there are in principle only three positions for the functions FR, the two functions FR can, for example, be placed directly on either side of the middle subgroup 110. Alternatively, the two functions FR could for example be placed directly on either side of the first subgroup 110 in FIG. 12. As can be seen at this point, in order to allocate 16 functions F1, F2, F3, it is necessary to repeat the subpattern 110 according to FIG. 13 twice in succession.

For example, alternatively, one can proceed without reducing: this results in six (Dd1=6) subpatterns 110, each with two functions to be allocated (QD1=2) and a remainder R1=4, cf. FIG. 14. The remaining functions FR are to be distributed as uniformly as possible among the subpatterns 110, FIG. 15. Given the number of intermediate positions for the four functions FR, the four functions FR can, for example, be placed symmetrically and individually around the two middle subgroups 110 and after the first (from the left) subgroup 110 and before the last subgroup 110. However, it is also possible to proceed as described above: if the remainder R (R2) has a set with nR functions, then a function of the remainder R (R2) can be assigned to the first nR subpatterns 110, in particular placed before or after them. Or, starting from a first subpattern 110, to which a function of the remainder R is assigned, in particular placed before or after, the following allocations of the functions F2 of the remaining (here five) functions F2 from the remainder can be assigned to, in particular placed before or after, the particular subpattern 110 at a certain regular interval, here in each case after a further sub-group 110, preferably placed before or after as in the first subpattern 110. It is considered optimal if a function from the remainder is placed after a particular subpattern 110, starting with a first subpattern 110, and this is repeated at a certain regular interval, here after every third subpattern 110.

As can be seen by comparing the duplicated arrangement of the subgroups 110 after incorporating the remaining functions FR according to FIG. 13 (sub-plan TP1), with the arrangement of the sub-plan TP1 according to FIG. 15, there is no difference in the ratio of the functions F1, F2, F3 to be allocated and the positions of the functions. Due to the ratios of the allocations, it again does not matter whether this basic pattern is allocated in the order from left to right or from right to left.

In this example, a number n4 of functions FP is determined, wherein the number n4 corresponds to the size of the remainder R. The basic pattern (100), or a sub-plan, is formed from this number n4 of functions FP and with the number n3 of subpatterns 110. The number n4 of functions FP of the remainder is distributed uniformly, in particular as uniformly as possible, over the number n3 of subpatterns 110.

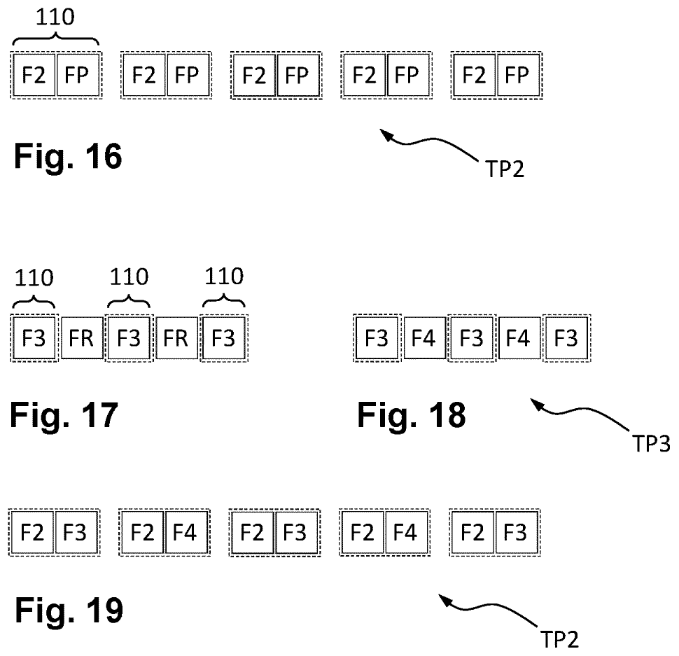

The second sub-plan TP2 concerns the relative position of the functions F2, F3 and F4 to each other. From the numbers n2=5, n3=3 and n4=2 of the allocations S4, for Dd2=10 and Dr2=5 QD2=2 results. This results in five subpatterns 110 of the second sub-plan TP2, with a particular length of two allocations S4, wherein each subpattern 110 is to begin with an allocation S4 of a function F2. An allocation S4 of a function F2 is to be followed by a placeholder function FP to which a function F3 or F4 will be allocated, FIG. 16.

The third sub-plan TP3 concerns the relative position of the functions F3 and F4 to each other. From the numbers n3=3 and n4=2 of the allocations S4, for Dd3=5 and Dr3=3 QD3=1 and a remainder R=2 result. This results in three subpatterns 110 of the third sub-plan TP3, with a particular length of one allocation S4, wherein each subpattern 110 has only one allocation S4 of a function F3. The two functions FR from the remainder R=2 are preferably distributed uniformly among the three subgroups, e.g. on both sides of the middle subgroup 110, see FIG. 17. It is considered optimal if a function from the remainder is placed after a particular subpattern 110, starting with a first subpattern 110, and this is repeated at a certain regular interval, here after the second subpattern 110. The functions F4 that have not yet been allocated can now be directly assigned to the two functions FR due to the equality of the number of allocations S4 for the two functions FR from the remainder R=2 and the number of functions F4 to be allocated, FIG. 18. This results in the completed third sub-plan TP3.

The placeholder functions FP of the second sub-plan TP2 can now be filled from the completed third sub-plan TP3 by allocating them in order, FIG. 19.

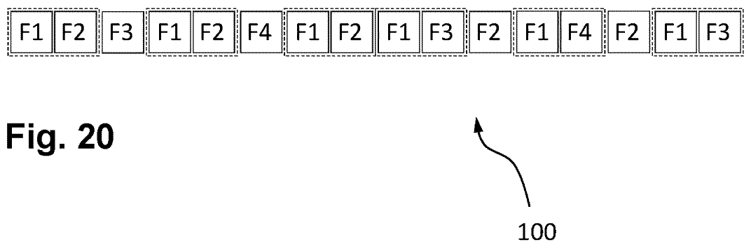

The placeholder functions FP and the remainder functions of the first sub-plan TP1 can now, by way of example, be filled from the completed second sub-plan TP2 by allocating them in order, FIG. 20. This results in the basic pattern 100 as allocation plan TP of the functions F1, F2, F3 and F4 to be allocated in the ratio n1/n2/n3/n4=6/5/3/2. Due to the ratios of the allocations S4, it again does not matter whether this basic pattern 100 is allocated in the order from left to right or from right to left.

FIG. 21 shows as temporal sequence of a trip of a motor vehicle 10 after the latter has been started at time t=0. The previously determined allocation plan according to FIG. 6 is used here by way of example. At time t=0, a drive phase S2 of the motor vehicle begins, which ends at time t1. At the end of this drive phase S2 at time t1, an overrun phase S3 begins, which is terminated between t4 and t5, at time t41. At time t1, i.e., at the beginning of the overrun phase S3, a first function F1 is allocated (allocation S4) and the corresponding program or the associated program sequence is processed before, optionally immediately before, reaching time t2. A function pause can be between the end of the execution of the function F1 and the next allocation S4, i.e., neither the function F1 nor the function F2 is executed or used over a time period not specified in more detail here. At time t2, the next allocation S4 takes place, which in this case represents an allocation S4 of the function F2. A function pause can again be between the end of the execution of the function F2 and the next allocation S4, i.e., neither the function F1 nor the function F2 nor any other function is executed or used over a time period not specified in more detail here. At time t3, an allocation S4 of the function F1 is performed. As was already the case beforehand, a function pause can again be between the end of the execution of the function F1 and the next allocation S4, i.e. neither the function F1 nor the function F2 nor any other function is executed or used over a time period not specified in more detail here. A next allocation S4 of a function F3 begins after time t4 has elapsed, but this function is only allocated and is not processed completely. Rather, this function F3 is terminated during its execution as a result of an end of the overrun phase S3 at time t41. A further drive phase S2 begins at time t41. This drive phase S2 is terminated at time t5 and the next overrun phase S3 begins. Since, according to this FIG. 21, the pattern of functions or the basic pattern 100 known by way of example from FIG. 6 and the associated description is processed, the previously allocated function F3 is followed by the one function F1 as the next allocation S4, which is followed after its processing at time t6 by a further allocation S4 of a function F2. After the time has elapsed, at time t61, this function F2 is also aborted, or terminated before complete processing. At time t61, the next drive phase S2 begins, which is terminated at time t7. According to the aforementioned basic pattern 100, this next overrun phase S3 begins with an allocation S4 of a function F1, which is processed until time t8 (FIG. 21), or alternatively optionally with a pause before time t8, i.e., between times t7 and t8. According to the basic pattern 100, this function F1 is then followed an allocation S4 of a function F3. At the end of the pass through the function F3 at time t9 there follows an allocation S4 of a further function F1, and this is followed by an allocation S4 of a further function F2 at time t10, which function is however likewise terminated at time t101 after a certain time and without completely passing through the function F2 (abort of the function). Thus, all provided allocations S4 of the basic pattern 100 according to FIG. 6 have been allocated. The abort is carried out due to the next subsequent drive phase S2. After a further drive phase S2 has been passed through, is terminated at time t11 and thus followed by a new overrun phase S3, a further allocation S4 of a function F1 is carried out, the first provided allocation S4 of a function F1 of the next basic pattern 100, which, after its execution, is followed at time t12 by a further allocation S4 of a function F2, which is likewise not processed completely, because it is terminated at time t121 due to the beginning drive phase S2. The further drive phase S2 follows until time t13. At this time, a further overrun phase S3 and an allocation S4 of a function F1 begin again between times t13 and t14, which is then followed by an allocation S4 of a function F3 at time t14, which is again terminated at time t141 after incomplete processing. As can be seen when viewing this FIG. 21, a basic pattern 100 is processed once overall between time t1 and time t101, or allocations of all individual functions F1, F2, F3 are carried out according to the previously ascertained basic pattern 100. In the time period between time t11 and time t201, a further basic pattern 100 is implemented and the functions F1, F2, F3 are allocated accordingly.

Accordingly, FIG. 21 discloses a method for operating a motor vehicle 10 with a drive train 26, which has an internal combustion engine 19, wherein the motor vehicle 10 is operated during a trip, and the motor vehicle 10 is operated at least once in an overrun phase S3 during the trip, wherein it is provided that, during the overrun phase S3, a function F1, F2, F3, . . . Fi is allocated S4 for an execution. In this case, an allocation S4 of different functions F1, F2, F3, . . . Fi is carried out according to an allocation plan P. The allocation plan P has a basic pattern 100 of a sequence of allocations S4 of the plurality of, at least three, functions F1, F2, F3, . . . . Fi. An allocation S4 is performed in this sequence. If a function F1, F2, F3, . . . Fi of a basic pattern 100 is terminated after incomplete processing, the next function to be allocated of the basic pattern 100 is allocated according to the basic pattern 100. In this case, the function F1, F2, F3, . . . Fi that is terminated after incomplete processing is not the last function F1, F2, F3, . . . Fi of a or the basic pattern 100. In other words, the function F1, F2, F3, . . . Fi that is terminated after incomplete processing is followed in the basic pattern 100 by at least one further function F1, F2, F3, . . . Fi, which is allocated according to the basic pattern 100. This is shown in FIG. 21 in all basic patterns 100 shown there.

As described above, a function whose allocation is not carried out within the framework of this basic pattern can optionally be allocated outside a basic pattern, i.e., for example, between two basic patterns 100 or before a basic pattern 100 or after a basic pattern 100Di.

As shown in FIG. 21, a basic pattern 100 can be repeated.

Moreover, it should be noted at this point that repetition of the basic pattern 100 will take place in large numbers as expected. If it is assumed, for example, that a motor vehicle is operated over 100,000 km almost or only in city traffic and that two to three overrun phases S3 arise per kilometer, 300,000 overrun phases can be expected on this route, for example. If a basic pattern has ten allocations S4, for example, this means in the case of, by way of example, one allocation S4 per overrun phase that a corresponding basic pattern can be repeated almost 30,000 times per 100,000 km. Using the basic pattern, it is possible for the allocations of a plurality of functions to be distributed as uniformly as possible in relation to a driving cycle (this corresponds to a trip or a test cycle).

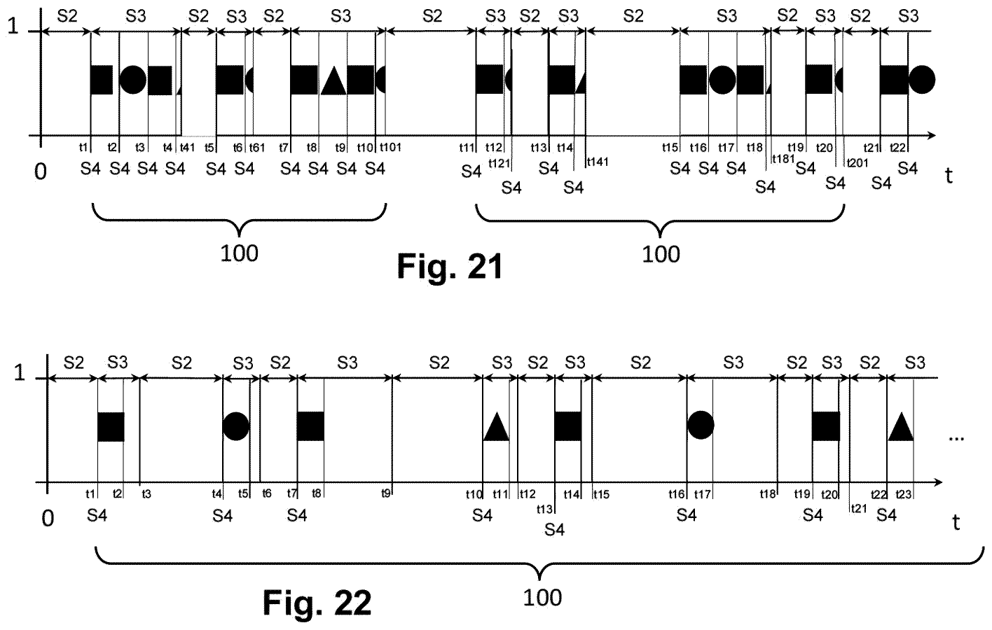

FIG. 22 shows a second exemplary embodiment for allocations S4 of the functions F1, F2, F3, . . . Fi according to the prepared basic pattern 100 according to FIG. 6. According to the sequences provided there, drive phases S2 and overrun phases S3 alternate. They start at the times given. In contrast to the preceding exemplary embodiment, only one function F1, F2, F3, . . . . Fi is allocated per overrun phase S3. Accordingly, only one function F1 is allocated for the first overrun phase S3 beginning at time t1. After the complete execution thereof, time t2, no further function F1, F2, F3, . . . Fi is allocated during this overrun phase S3. After the end of this overrun phase S3, a further drive phase S2 takes place, which begins at time t3 and is terminated at time t4. At this time t4, a further overrun phase S3 begins, which ends at time t6. At the beginning of this overrun phase S3 at time t4, a function F2 is allocated. After a further drive phase S2 between times t6 and t7, a further overrun phase S3 begins between times t7 and t9. According to the basic pattern 100, a function F1 is now allocated at time t7, wherein the function is processed at time t8. A further drive phase S2 takes place between time t9 and time t10. At the beginning of the next overrun phase S3 at time t10, a function F3 is allocated, which is processed at time t11. Until the end of the overrun phase S3 at time t12, no further allocation of a function F1, F2, F3, . . . Fi takes place. A further drive phase S2 takes place between time t12 and time t13. Only at the beginning of a next overrun phase S3 at time t13 begins an allocation of the next function F1, which ends at time t14. Until the end of the overrun phase S3, no further allocation of a function F1, F2, F3, . . . Fi takes place again. Between the end of the overrun phase S3 at time t15, which at the same time is the beginning of the next drive phase S2, which ends at time t16, no allocation of a function F1, F2, F3, . . . Fi takes place again. At the beginning of the next overrun phase S3 at time t16, the next allocation of a function F2 takes place, which ends at time t17. After the end of the overrun phase S3 at time t18 and the simultaneous beginning of the next drive phase S2 at time t18 until the end t19 thereof, no allocation of a function F1, F2, F3, . . . Fi takes place. For the overrun phase S3 at time t19 (beginning) until the end thereof at time t21, the allocation of a function F1 takes place, which is processed between time t19 and time t20. After this allocation S4, a further allocation of a function F3 follows after a drive phase S2 between t21 and t22. According to the allocation plan according to FIG. 6 and the partial representation of the allocations S4 according to an allocation plan P, after this allocation S4 of a function F3, two further allocations of functions F1 and F2 follow, which here are all separated from drive phases S2. With this last allocation of the function F2, a first basic pattern 100 of the mentioned allocation plan P has thus been processed. As intended, it is provided that, for all further overrun phases S3, a further or only further basic patterns 100 are processed or the functions F1, F2, F3, . . . Fi are allocated according to a basic pattern 100.

A process (preceding step), which is referred to as a so-called “demand step,” can still precede each allocation S4 or the actual beginning of an execution of a function F1, F2, F3, . . . . Fi. This step is provided within the framework of the method sequence in order to request the actual calling of the function F1, F2, F3, . . . Fi at the corresponding location. This means that, at the beginning of a drive phase S2, a “demand step” can first be executed, which is or can be provided within the framework of the method sequence in order to request the actual calling of the function F1, F2, F3, . . . Fi at the corresponding location. This can then possibly mean that the actual beginning of the execution of a function F1, F2, F3, . . . Fi begins only after the particular execution of the demand step or after the preceding step. The representations in the figures are simplified in this respect.

1-27. (canceled)

28. A method for operating a device, the device having one operating phase and another operating phase, the method comprising the following:
during the other operating phase of the device, allocating a function for an execution;
wherein an allocation of at least three different functions is carried out according to an allocation plan.

29. The method according to claim 28, wherein the allocation plan has at least one basic pattern, which is formed from a plurality of sub-plans.

30. The method according to claim 29, wherein a number of the different functions is allocated, wherein a number of the sub-plans from which the allocation plan is formed is at least the number of different functions reduced by 1.

31. The method according to claim 28, wherein the allocation plan has at least one basic pattern of a sequence of allocations of the at least three different functions, and the allocation is performed in the sequence.

32. The method according to claim 31, wherein the allocation of the at least three different functions according to the basic pattern is carried out by repeating the basic pattern during the allocation of the at least three different functions.

33. The method according to claim 31, wherein a function is allocated only within a framework of the basic pattern.

34. The method according to claim 31, wherein the basic pattern has a specifiable ratio of allocations of the at least three different functions.

35. The method according to claim 31, wherein a function of the basic pattern is terminated after incomplete processing.

36. The method according to claim 35, wherein the function that is terminated after incomplete processing is followed in the basic pattern by at least one further function, wherein a next function to be allocated of the basic pattern is allocated according to the basic pattern.

37. The method according to claim 36, wherein the function that is terminated after incomplete processing is a last allocated function of the basic pattern, and the next function to be allocated of the basic pattern is allocated according to a next basic pattern.

38. The method according to claim 29, wherein a sub-plan is determined by the following steps:
determining a dividend and determining a divisor;
performing a step that is at least equivalent to an integer division with the dividend and the divisor;
wherein, to determine the dividend, a plurality of types of functions and a sum of their specified numbers of allocations of a multiple of the basic pattern are used, and a set is thereby formed;
wherein, to determine the divisor, a plurality of types of functions and a sum of their specified numbers of allocations of the multiple of the basic pattern are used, and a set is thereby formed;
wherein the plurality of types of functions f the dividend are more than the plurality of types of functions of the divisor;
ascertaining an integer quotient of the integer division in a step; and
determining a remainder of the integer division in a step.

39. The method according to claim 38, wherein, before performing the step, either: (i) the dividend and the divisor are fully reduced, or (ii) it is determined that the dividend and the divisor are fully reduced.

40. The method according to claim 38, characterized in that a number of the subpatterns that are part of the basic pattern is determined in a step, wherein the number of the subpatterns corresponds to the divisor.

41. The method according to claim 38, wherein a number of allocations of a subpattern is determined, wherein the number of allocations corresponds to a magnitude of the integer quotient.

42. The method according to claim 41, wherein a number of functions is determined, wherein the number of the functions corresponds to the magnitude of the remainder.

43. The method according to claim 42, wherein the basic pattern is formed from the number of functions with the number of subpatterns.

44. The method according to claim 42, wherein the number of functions is uniformly distributed to the number of subpatterns.

45. The method according to claim 28, wherein the allocation plan is stored in a memory.

46. The method according to claim 45, wherein the allocation plan is read from the memory.

47. The method according to claim 31, wherein, in connection with allocating the at least three different functions, a feature is stored that makes it possible to determine a next function to be allocated of the basic pattern.

48. The method according to claim 47, wherein, in connection with allocating the at least three functions, a current position in the allocation plan is stored, the current position including a last allocated position or a next position to be allocated.

49. The method according to claim 28, wherein the allocation plan is generated in a control unit in a motor vehicle.

50. The method according to claim 28, wherein the allocation plan is generated outside a control unit and is then stored in a memory.

51. The method according to claim 28, wherein the at least three different functions include a function for monitoring a quantity of injected fuel and a function for adapting a small quantity of injected fuel.

52. A non-transitory machine-readable memory in which is stored a computer program is stored for operating a device, the device having one operating phase and another operating phase, the computer program, when executed by a computer, causing the computer to perform the following:
during the other operating phase of the device, allocating a function for an execution;
wherein an allocation of at least three different functions is carried out according to an allocation plan.

53. A control unit configured to operate a device, the device having one operating phase and another operating phase, the control unit configured to:
during the other operating phase of the device, allocate a function for an execution;
wherein an allocation of at least three different functions is carried out according to an allocation plan.
